(19) United States
(12) Patent Application Publication
(10) Pub. No.: US 2004/0161572 A1
(43) Pub. Date: Aug. 19, 2004

(54) Simulated decal air freshener

(76) Inventors: Robert A. Juran, Independence, OH (US); Craig M. Saunders, Rocky River, OH (US); Trevor L. Jackson, Kirtland, OH (US)

Correspondence Address: Fay, Sharpe, Fagan,, Minnich & McKee, LLP, 7th Floor, 1100 Superior Avenue, Cleveland, OH, 44114-2579, US

(21) Appl. No.: 10/750,286

(22) Filed: Dec. 31, 2003

Related U.S. Application Data
(60) Provisional application No. 60/437,476, filed on Jan. 2, 2003.

(51) Int. Cl. B32B 9/00

(52) U.S. Cl. 428/41.8; 428/58; 428/63

(57) ABSTRACT

An unobtrusive air freshener is planar in nature and resembles a parking or membership sticker. The air freshener is composed of a fragrance carrying card surrounded by a number of layers of plastic film, one of which is in an adhesive free static cling sheet adapted to adhere to a windshield or other glass surface and be removable without leaving a residue.

This application claims priority of provisional application Serial No. 60/437,476, filed Jan. 2, 2003.

### BACKGROUND OF THE INVENTION

This invention relates generally to air fresheners which release a scent or absorb a scent in a confined space and more particularly to a thin planar air freshener which can be applied to a flat glass surface.

Confined spaces often develop an odor which can be less than pleasant. Kitchens, bathrooms, automobile interiors and other spaces often suffer from odor problems. In the past, people have addressed these odor problems by positioning air fresheners which release a scent into these spaces. Another approach has been taken with smaller spaces such as closed refrigerators. Refrigerators sometimes develop an odor based upon some of the food ingredients stored in a refrigerator. One remedy used with refrigerators is the positioning of an opened box of baking soda in the refrigerator, the thought being that the baking soda absorbs the offensive odor.

Prior approaches have shortcomings. An easily visible air freshener, in some situations, can be viewed as a statement that there is an odor problem in the space involved. Moreover, some air fresheners have a less than pleasing appearance to many people. Particularly in an automobile setting, an air freshener needs to be fixed in place because of the motion of the automobile and replaceable when exhausted. These requirements and the requirement for a pleasing appearance are somewhat contradictory.

### SUMMARY OF THE INVENTION

The present invention provides an air freshener which is planar and unobtrusive resembling a parking or club membership decal and which is easily fixed in place in an automobile and easily removed when exhausted.

In accordance with the present invention, an air freshener is constructed from several layers including a static cling layer having a static cling face adapted to cling to the interior surface of the windshield of an automobile, an odor abating member permanently fixed to the static cling layer bearing a printed design resembling a parking or club membership decal and carrying a charge of fragrance and a metering layer fixed to the odor abating member and static cling layer allowing the fragrance to pass into the automobile interior volume at a selected rate.

Yet further in accordance with the invention, a non-adhesive planar air freshener is provided comprising a flexible static cling sheet having an adhesive free first face adapted to removably cling to a glass surface, a second face, a first dimension, a second dimension and a footprint. A static cling free sheet is provided having a first face adhered to the static cling sheet and a second face, the static cling free sheet has a first dimension, a second dimension and a footprint. The static cling free sheet has a first dimension, a second dimension and footprint identical to the static cling sheet first dimension, second dimension and footprint. An adhesive sheet is provided having an adhesive first face, an adhesive second face, a first dimension smaller than the static cling sheet first dimension and a footprint smaller than the static cling first sheet, the adhesive sheet first face being adhered to the static cling free sheet second face. A planar fragrance member is provided having a first face, a second face, a first dimension equal to the adhesive sheet first dimension, a second dimension and a footprint. The fragrance member carries a fragrance adapted to emit a scent into a surrounding atmosphere, the fragrance member first face being fixed to the adhesive sheet second face. Additionally, a metering sheet is provided having a first face, a second face, a first dimension, a second dimension and a footprint. The metering sheet first face is fixed to at least one of the static cling free sheet, the adhesive sheet and the fragrance member such that at least a portion of the metering sheet first face is in contact with the fragrance member second face. The metering sheet is adapted to allow passage of the scent at a selected rate.

Yet still further in accordance with the invention, a removable non-adhesive planar air freshener is provided comprising a first sheet having an adhesive free static cling first face adapted to removably cling to a glass surface, a second face, a first planar dimension, a second planar dimension and a footprint. A planar fragrance member is provided having a first face, a second face, a first planar dimension, a second planar dimension and a footprint. The fragrance member first face is permanently fixed to the first sheet second face entirely within the footprint of the first sheet. The fragrance member is porous and carries a volatile fragrance. The fragrance member is adapted to release the volatile fragrance at a selected rate adapted to provide air freshening in a confined space for several weeks.

Yet further in accordance with the invention, a removable, non-adhesive planar air freshener is provided comprising a first sheet having an adhesive free static cling first face adapted to removably cling to a glass surface, a second face, a first planar dimension, a second planar dimension and a footprint. A planar display sheet is provided having a first face, a second face and a footprint, the display sheet first face is permanently fixed to the first sheet second face entirely within the first sheet footprint and bears a printed design. A planar odor abating member is provided having a uniform thickness, a first face, a second face, a first planar dimension, a second planar dimension and a footprint. The odor abating member first face is in contact with the display sheet second face. A metering sheet is provided having a first face in contact with the odor abating member second face and having a first planar dimension larger than the odor abating member first planar dimension. A portion of the metering sheet first face is permanently fixed to the first sheet second face.

Still further in accordance with the invention, a removable non-adhesive planar air freshener is provided comprising a first sheet having an adhesive free static cling first face adapted to removably cling to a glass surface, a second face, a first planar dimension, a second planar dimension and a footprint. A planar odor abating member is provided having a first face, a second face, a first planar dimension, a second planar dimension and a footprint. The odor abating member first face is permanently fixed to the first sheet second face entirely within the footprint of the first sheet. The odor abating member is porous and allows air circulation therethrough and is adapted to provide air freshening in a confined space for several weeks.

Yet further in accordance with the invention, a non-adhesive planar air freshener is provided comprising a thin flexible static cling sheet adapted to removably cling to a glass surface; a static cling free barrier sheet having a footprint identical to the footprint of the static cling sheet, the barrier sheet adhering to the static cling sheet; a double sided adhesive sheet having a footprint smaller than the footprint of the static cling sheet adhering to the center of the barrier sheet; a planar fragrance member having a footprint similar to the footprint of the adhesive layer fixed to the adhesive layer and carrying a fragrance; and, a metering sheet having a footprint at least as large as the fragrance member footprint covering the fragrance member and fixed to the barrier film, the metering sheet allowing the passage of air so that the fragrance may exit the fragrance member.

Yet further in accordance with the invention, the metering sheet has a multiplicity of holes allowing passage of the scent from the fragrance member.

Yet further in accordance with the invention, the static cling sheet is a vinyl plastic sheet or a polyvinyl chloride plastic sheet.

Still further in accordance with the invention, the fragrance member is a fiberboard, paperboard or paper sheet having a printed design on the side facing the static cling sheet and having a fragrance carrying fluid absorbed therein.

Still further in accordance with the invention, all of the layers of the air freshener except the fragrance member are transparent and the fragrance member is printed to present a design making the overall air freshener resemble a parking permit or club membership decal when positioned on the interior surface of the windshield of an automobile.

Yet further in accordance with the invention, the air freshener has a maximum thickness and planar dimensions, such as width and height, with at least one of the planar dimensions being at least 10 times the thickness so that the air freshener strongly resembles an automobile parking or membership decal.

Still further in accordance with the invention, the air freshener is solar activated. When placed on the windshield of a car in a sunny location, the fragrance member will be heated as it is opaque and, preferably, dark in color. Because the fragrance member is relatively large in surface area and thin, it will heat through its depth quickly. The fragrance material in the fragrance member will vaporize more quickly, increasing the rate of fragrance release.

In accordance with another aspect of the invention, the fragrance member may be replaced with an odor abatement member comprised of a body of baking soda or other odor absorbing material fixed with a binder between the sheet layers of the air freshener described above.

It is the principal object of the present invention to provide an air freshener product which can be applied to a glass surface without the use of adhesives, removed from that glass surface without leaving a residue yet remain in place through its intended life.

It is another object of the present invention to provide an air freshener which, when applied to the interior surface of an automobile windshield, resembles a parking decal or club membership decal.

It is another object of the invention to provide a solar activated air freshener which will emit more fragrance on hot, sunny days when objectionable odors are sometimes stronger.

It is still another object of the present invention to provide an air freshener which can be applied simply by positioning the air freshener against a glass surface and pressing it into place and repositioned it by simply lifting it off and reapplying it without leaving an adhesive residue.

It is another object of the present invention to provide an air freshener which is easy to manufacture, inexpensive and easily installed and removed by the consumer.

It is yet another object of the present invention to provide an odor abatement type air freshener containing a body of baking soda or other odor abatement material contained in a transparent sheet housing also containing a printed paper resembling a decal.

It is still another object of the present invention to provide an odor abatement type air freshener which can be easily adhered to a glass shelf in a refrigerator and removed without leaving an adhesive residue.

These and other objects of the present invention will become apparent to those skilled in the art from the following description taken in conjunction with the accompanying drawings wherein:

### BRIEF DESCRIPTION OF THE DRAWINGS

FIG. 1 is a front view of an air freshener made in accordance with the present invention, the front side being the side adapted for application to an automobile windshield interior surface;

FIG. 2 is a back view of the air freshener of FIG. 1;

FIG. 3 is a side view of the air freshener of FIGS. 1 and 2 showing the thin profile of the air freshener;

FIG. 4 is a cross section of the air freshener taken along line A-A of FIG. 2;

FIG. 5 is an enlarged detail of the portion of the cross section of FIG. 4 marked B in FIG. 4;

FIG. 6 is an exploded view showing the individual elements used to construct the preferred embodiment shown on FIGS. 1-5 and their interrelationship; and,

FIG. 7 is an exploded view showing the individual elements used to construct a second embodiment in accordance with the present invention.

### PREFERRED EMBODIMENT

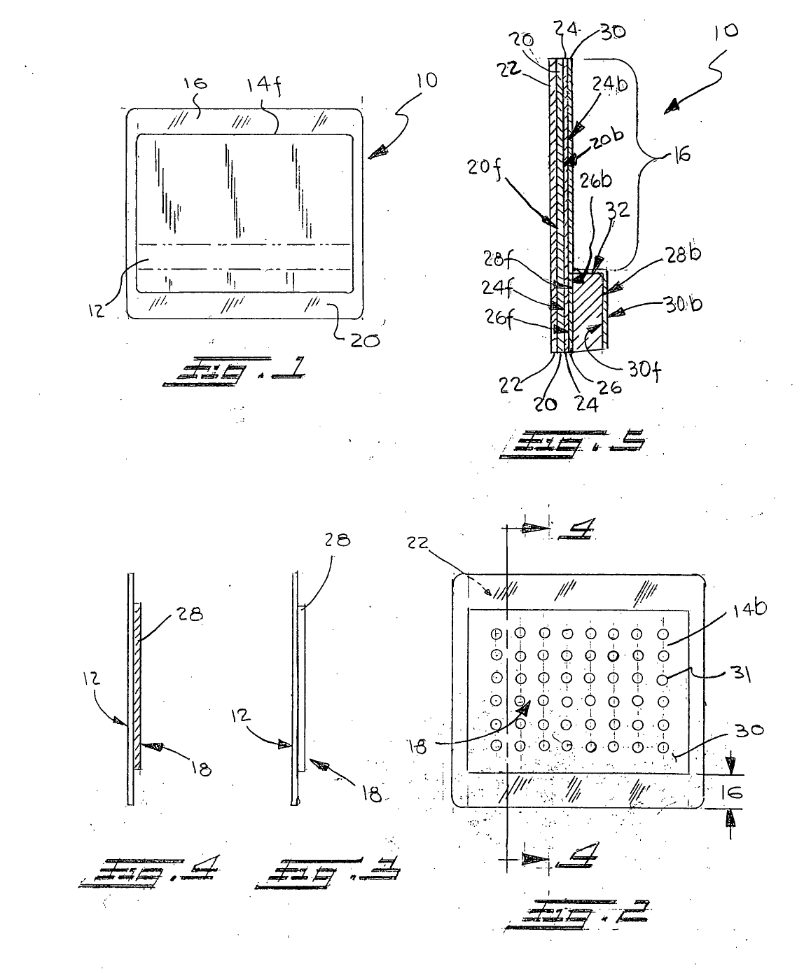

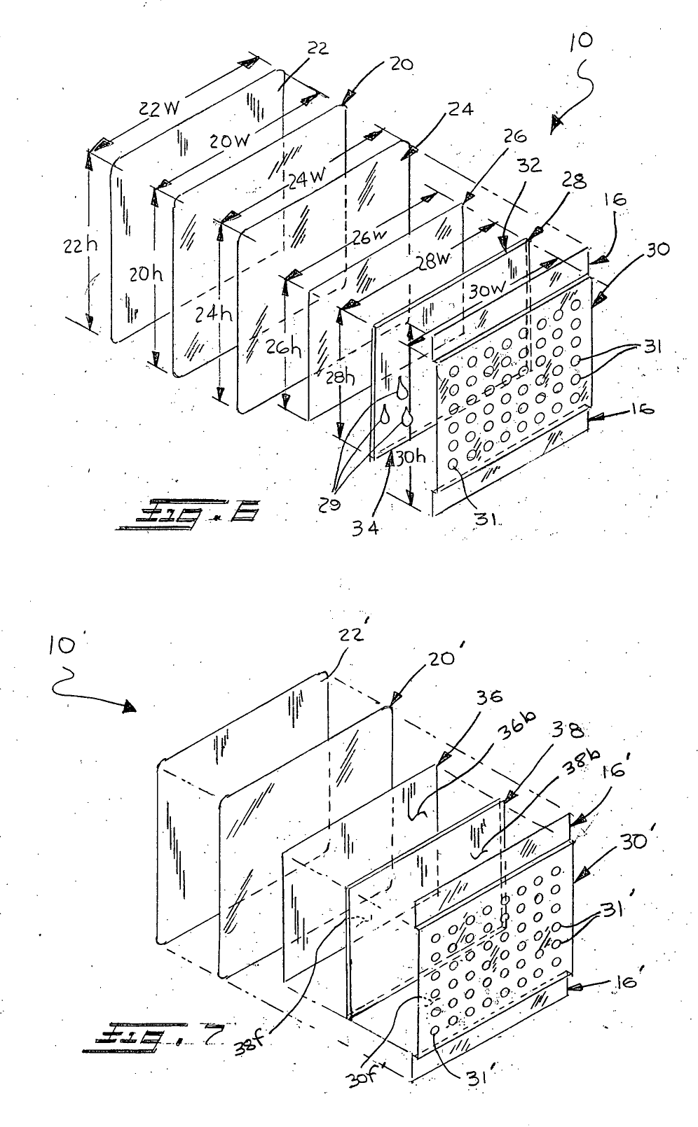

Referring now to the drawings wherein the showings are for the purposes of illustrating a preferred embodiment of the invention and not for the purposes of limiting same, FIG. 1 shows an air freshener 10 in accordance with the preferred embodiment of the invention. The front view or side 12 of the air freshener 10 is seen in FIG. 1. The front side 12 is the side that can be seen from the outside of an automobile when the air freshener is applied to the inside surface of the windshield of an automobile. The front side 12 comprises a central printed area 14f surrounded by a transparent margin 16. The central printed area 14f can be provided with a design, possibly including words and serial numbers, simulating a parking sticker or club membership decal of the type frequently seen on automobile windshields. The central area 14f can be surrounded by a transparent margin 16 which can appear to be transparent plastic. Of course, the margins 16 could be translucent or even opaque so long as the central printed area 14f and its design are visible at the front side 12.

Referring now to FIG. 2, a back view or side 18 of the air freshener 10 is shown. Some of the structural elements of the back side 18 are emphasized in FIG. 2 for purposes of clarity. In use, the back side 18 can have a resemblance similar to the front side 12. That is, a back face central printed area 14b is surrounded by the transparent margin 16. The back face central printed area 14b is preferably opaque with a printed legend thereon either identical to the printed legend on the front face central printed area or, as shown, different from the front face printed area 14f. Of course, the back face central printed area 14b could be left opaque and blank without departing from the spirit of the invention.

Thus, the appearance of the air freshener 10 from both the front view 12 and the back view 18 strongly resembles a parking or membership decal as is frequently seen on the inside of an automobile windshield.

The elements used to construct the air freshener 10 are seen in FIG. 6. A static cling or first sheet 20 is the frontmost element of the air freshener 10. A protective backing or cover 22 can be provided to protect the static cling sheet 20 from contaminants until installation is desired and/or between installations. The protective cover 22 can help to preserve the static cling properties of the static cling sheet 20. The static cling sheet 20 can be generally rectangular with rounded corners and include a width or first planar dimension 20w and a height or second planar dimension 20h. Along with a footprint 20A generally defined as the product of the width dimension 20w and the height dimension 20h (20w×20h). The static cling sheet 20 can be a uniformly thin sheet, typically 2 to 6 mils, and is selected to have static cling properties on its front or first face 20f. Certain films, such as certain vinyl films and certain polyvinyl chloride films are known to cling to glass surfaces without the need of an adhesive. The static cling characteristic of plastic film and sheets has been used in the past for products such as food wrap.

A barrier or static cling free sheet 24 is provided with an adhesive on its front or first face 24f (the face facing the static cling sheet 20), a width or first dimension 24w and a height or second dimension 24h. The width dimension 24w and height dimension 24h of the barrier sheet 24 can be identical to the width 20w and height dimension 20h, respectively, of the static cling sheet 20. The barrier sheet 24 can be generally rectangular with round corners and have a footprint 24A identical to the footprint 20A of the static cling sheet 20. The barrier sheet 24 can be permanently fixed, by means of the adhesive on its front face 24f, to a back or second face 20b of the static cling sheet 20 in registry with the static cling sheet 20.

An adhesive sheet 26 is provided with an adhesive on both its front or first face 26f and its back or second face 26b. The adhesive sheet 26 has a width or first dimension 26w slightly smaller than the width dimension 20w of the static cling sheet 20 and a height or second dimension 26h slightly smaller than the height dimension 20h of the static cling sheet 20. The adhesive sheet 26 can be fixed to the center of the back or second face 24b of barrier sheet 24. The adhesive sheet 26 can be generally rectangular with round or square corners and have a foot print 26A generally defined as the product of the width dimension 26w and the height dimension 26h (26w×26h).

A fragrance board or planar fragrance member 28 can be a thin fiberboard, paperboard or paper rectangle having a width or first planar dimension 28w and a height or second planar dimension 28h. The width dimension 28w and the height dimension 28h of the fragrance board 28 can be identical to the width 26w and height dimensions 26h, respectively, of the adhesive sheet 26. The fragrance board 28 can be generally rectangular with round or square corners and have a foot print 28A generally defined as the product of the width dimension 28w and the height dimension 28h (28w×28h). The fragrance board 28 is preferably 65 mils or less thick. The fragrance board 28 can be opaque and printed with a design on both its front or first face 28f, which forms the central printed area 14f, and its rear surface, which forms the back or second face 28b central printed area 14b. The fragrance board 28 is shown in FIG. 6 without printing for purposes of clarity. The fragrance board 28 can be porous. The fragrance board 28 carries a quantity of fragrance, shown in FIG. 6 schematically as fragrance drops 29. The fragrance 29 is applied as a liquid and is volatile giving off a scent when exposed to air. The fragrance 29 is absorbed into the substance of the fragrance board 28 relatively uniformly and will not be visible as drops 29.

A thin plastic metering sheet 30 is provided with adhesive on the front or first face 30f facing the fragrance board 28. The metering sheet is provided with a non-adhesive back or second face 30b for ease of handling and placement to a desired location. The metering sheet 30 can be rectangular with a width or first dimension 30w identical to the width dimension 28w of the fragrance board 28 and a height dimension exceeding the height dimension 28h of the fragrance board 28 and (an applied height or second dimension 30h) identical to the height dimension 20h of the static cling sheet 20. The metering sheet 30 can be generally rectangular with round or square corners and have a foot print 30A generally defined as the product of the width dimension 30w and the height dimension 30h (30w×30h). The metering sheet 30 can be provided with a multiplicity of through holes 31. In the embodiment shown, the metering sheet 30 is provided with 48 holes arranged as six rows of eight holes each. The number and size of the holes 31 are selected to provide an appropriate release rate for the fragrance 29 from the fragrance board 28.

The static cling sheet 20, the barrier sheet 24, the adhesive sheet 26 and the metering sheet 30 can be all fabricated from thin transparent plastic film. Moreover, all of these films can be flexible. The fragrance board 28 can be fabricated from fiberboard, paperboard or paper depending upon the amount of and type of fragrance 29 to be carried in the product and the desired thickness. A larger amount of fragrance can be carried in a thicker board. A thinner paper fragrance board will be more flexible and can be used with concentrated fragrances which do not require much volume.

The barrier sheet 24 can be fabricated from a plastic film selected to be impervious to the adhesives used and to the fragrance carried by the fragrance board 28. It protects the vinyl cling sheet 20 from possible attack by the fragrance.

As shown in FIGS. 1 and 2, the fragrance board 28 is preferably printed on both sides 28f, 28b to resemble a parking or membership sticker. Paper, cardboard and fiberboard are easily printed. None of the other layers of the air freshener 10 needs to be printed. None of the other layers of the air freshener 10 need to be colored in any way.

The adhesive sheet 26 may be replaced by an adhesive layer (not shown) applied to a portion of the barrier sheet 24 or the fragrance board 28.

The barrier sheet 24 provides the advantage of protecting the static cling sheet 20 from attack by the adhesives used in other layers 26, 30 and from attack by the fragrance 29. If a fragrance 29 is selected which will not attack the static cling sheet 20, it may be possible to dispense with the barrier sheet 24. However, the barrier sheet 24 also masks the static cling sheet 20 from the interior of the automobile. This prevents the second face 20b of the static cling sheet 20 from drawing and holding dust and other dirt elements and having a dirty appearance.

As can be seen in FIG. 5, the metering sheet 30 lays against the barrier sheet 24 in the margin areas 16. The metering sheet 30 also lays against top and bottom edges 32, 34 of the fragrance board 28 and the back face 28b of the fragrance board 28. Because of this, the unapplied metering sheet 30 will have a height dimension (not illustrated) slightly greater than height dimension 20h of the static cling sheet 20 so that its “as applied” height dimension 30h is equal to the height dimension 20h of the static cling sheet 20 and barrier sheet 24.

A preferred location for mounting the air freshener 10 is near the lower left corner of an automobile windshield. In this position, the air freshener 10 is exposed to sunlight on warm sunny days. The sunlight will have little effect on the transparent layers of the air freshener 10. The fragrance board 28 can be opaque and, preferably contains darkly colored areas. Sunlight will penetrate through a transparent automobile windshield and the transparent film layers of the air freshener 10 and illuminate and heat the fragrance member. The heated fragrance member will release fragrance into the automobile interior at an increased rate when compared to a cold air freshener as most volatile materials evaporate more quickly when heated. The air freshener is, thus, sunlight activated. On the other hand, in a northern winter, the air freshener will be “deactivated” when a car is parked in a cold garage overnight. The air freshener will be reactivated when the driver turns on the heat, raising the temperature in the car interior. Thus, the air freshener 10 is automatically activated, at a variable rate, as needed only, extending its useful life.

With reference to FIG. 7, an air freshener formed in accordance with a second embodiment is illustrated. Like components are identified with like numerals including a primed (′) suffix and new components are identified with new numerals. As an alternative to the cardboard fragrance board 28 in an air freshener 10′, a thin rectangular block or odor abating member 38 of baking soda in a binder can be held in place by the metering sheet 30′ (see FIG. 7). A front or first face 38f of the odor abating member 38 can be in registry with an adhesive second face 36b of an adhesive or planar display sheet 36. A back or second face 38b of the odor abating member 38 can be in registry with the adhesive first face 30′f of the metering sheet 30′. The binder can be porous allowing the passage of air through the holes 31′, whereby odors in the air can be extracted and held in the block of baking soda. Similar to the fragrance board 28, the odor abating member 38 can be planar having a width or first dimension and a height or second dimension defining a footprint. This embodiment is particularly applicable to refrigerators. In this embodiment, the adhesive sheet 36 can be provided with a printed design on a front or first face 36f and function as a planar display sheet. The planar display sheet 36 can have a footprint similar to the footprint of the odor abating member 38.

Air fresheners 10, 10′ can be packaged in an air tight retail package such as a rib and groove closure plastic bag or a blister pack (not shown). In this way, the fragrance is contained on the fragrance board 28 (and odor abating member 38 preserved) until the package is opened by the consumer and the air fresheners 10, 10′ applied to the desired location. Air fresheners 10, 10′ are used by the consumer by simply pressing it against a smooth glass or similar surface at the desired location. One appropriate location is the lower left corner of an automotive windshield. A glass surface in a refrigerator or a glass-like surface in a refrigerator is also appropriate. The static cling sheets 20, 20′ will cling tightly to a smooth clean glass surface even in freezing or hot temperatures. Air fresheners 10, 10′ will remain in place for a period of weeks or months and can be easily removed by peeling it away from the windshield with a finger or thumbnail. Because no adhesives are used on the cling face, no adhesive residue is left on the windshield or other glass surface. Air fresheners 10, 10′ can be applied to any window, mirror, shower stall door, or other glass-like surface where it will stay in place until removed.

The static cling properties of vinyls and polyvinyl chloride films of the class usable in this invention are not defeated by high humidity or moisture. A non-obtrusive, easily installed, non-messy and easily removed air freshener is thereby provided.

While considerable emphasis has been placed herein on the structure of the preferred embodiments and the structural interrelationships between component parts of the preferred embodiments, it will be appreciated that many changes in the embodiments herein illustrated and described can be made without departing from the principles of the invention. Accordingly, it is to be distinctly understood that the foregoing descriptive matter is to be interpreted merely as illustrative of the preferred embodiments and not as a limitation.

Having thus described the invention, it is claimed:

1. A non-adhesive planar air freshener comprising:
a flexible static cling sheet having an adhesive free first face adapted to removably cling to a glass surface, a second face, a first dimension, a second dimension and a footprint;
a static cling free sheet having a first face adhered to said static cling sheet and a second face, said static cling free sheet having a first dimension, a second dimension and a footprint; said static cling free sheet first dimension, second dimension and footprint being identical to said static cling sheet first dimension, second dimension and footprint;
an adhesive sheet having an adhesive first face, an adhesive second face, a first dimension smaller than said static cling sheet first dimension and a footprint smaller than said static cling first sheet, said adhesive sheet first face being adhered to said static cling free sheet second face;
a planar fragrance member having a first face, a second face, a first dimension equal to said adhesive sheet first dimension, a second dimension and a footprint; said fragrance member carrying a fragrance adapted to emit a scent into a surrounding atmosphere, said fragrance member first face being fixed to said adhesive sheet second face; and,
a metering sheet having a first face, a second face, a first dimension, a second dimension and a footprint, said metering sheet first face being fixed to at least one of said static cling free sheet, said adhesive sheet and said fragrance member such that at least a portion of said metering sheet first face is in contact with said fragrance member second face, said metering sheet being adapted to allow passage of said scent at a selected rate.

2. The air freshener of claim 1 wherein said metering sheet has a multiplicity of holes allowing passage of said scent.

3. The air freshener of claim 1 wherein said static cling sheet is a vinyl plastic sheet.

4. The air freshener of claim 1 wherein said static cling sheet is a polyvinyl chloride plastic sheet.

5. The air freshener of claim 1 wherein said fragrance member is a fiberboard sheet having a printed design on at least said first face.

6. The air freshener of claim 1 wherein said fragrance member is a cardboard sheet having a printed design on at least said first face.

7. The air freshener of claim 1 wherein said fragrance member is a paper sheet having a printed design on at least said first face.

8. The air freshener of claim 1 wherein said static cling sheet, said adhesive sheet and said metering sheet are transparent.

9. The air freshener of claim 1 wherein said air freshener has a maximum thickness and said static cling sheet first dimension is at least ten times greater than said maximum thickness.

10. The air freshener of claim 9 wherein said static cling sheet second dimension is at least ten times greater than said maximum thickness.

11. The air freshener of claim 1 wherein said planar fragrance member is opaque.

12. The air freshener of claim 11 wherein said planar fragrance member has a thickness and said fragrance member first dimension is substantially greater than said thickness.

13. The air freshener of claim 12 wherein said fragrance member first dimension is at least ten times said thickness.

14. The air freshener of claim 13 wherein said fragrance member first dimension and said fragrance member second dimension are both at least ten times said thickness.

15. The air freshener of claim 11 wherein said fragrance member is dark in color.

16. The air freshener of claim 11 wherein said fragrance member is adapted to be heated by solar radiation and emit increased fragrance when heated.

17. The air freshener of claim 16 wherein said fragrance member is adapted to emit decreased fragrance when cooled.

18. The air freshener of claim 17 wherein said air freshener is adapted to emit increased fragrance in a warm sunny environment and decreased fragrance in a cool, dark environment.

19. The air freshener of claim 18 wherein said fragrance member is printed in a pattern including dark inks whereby said fragrance member performs the duty of distinguishing said air freshener as a decal and the duty of automatically variably activating said air freshener.

20. A removable non-adhesive planar air freshener comprising:
a first sheet having an adhesive free static cling first face adapted to removably cling to a glass surface, a second face, a first planar dimension, a second planar dimension and a footprint, a planar fragrance member having a first face, a second face, a first planar dimension, a second planar dimension and a footprint, said fragrance member first face permanently fixed to said first sheet second face entirely within the footprint of said first sheet, said fragrance member being porous and carrying a volatile fragrance, said fragrance member adapted to release said volatile fragrance at a selected rate adapted to provide air freshening in a confined space for several weeks.

21. A removable, non-adhesive planar air freshener comprising:
a first sheet having an adhesive free static cling first face adapted to removably cling to a glass surface, a second face, a first planar dimension, a second planar dimension and a footprint;
a planar display sheet having a first face, a second face and a footprint, said display sheet first face permanently fixed to said first sheet second face entirely within said first sheet footprint and bearing a printed design;
a planar odor abating member having a uniform thickness, a first face, a second face, a first planar dimension, a second planar dimension and a footprint,
said odor abating member first face being in contact with said display sheet second face; and,
a metering sheet having a first face in contact with said odor abating member second face and having a second planar dimension larger than said odor abating member second planar dimension, a portion of said metering sheet first face being permanently fixed to said first sheet second face.

22. The air freshener of claim 21 wherein said odor abating member is a body of baking soda.

23. The air freshener of claim 22 wherein said odor abating layer is a body of baking soda in a binder.

24. The air freshener of claim 23 wherein said metering sheet is a thin plastic sheet having an array of holes therein.

25. A removable non-adhesive planar air freshener comprising:
a first sheet having an adhesive free static cling first face adapted to removably cling to a glass surface, a second face, a first planar dimension, a second planar dimension and a footprint,
a planar odor abating member having a first face, a second face, a first planar dimension, a second planar dimension and a footprint, said odor abating member first face permanently fixed to said first sheet second face entirely within the footprint of said first sheet, said odor abating member being porous and allowing air circulation therethrough and adapted to provide air freshening in a confined space for several weeks.

26. The air freshener of claim 25 further including a metering sheet having a first face in contact with said odor abating member second face and having a second planar dimension larger than said odor abating member second planar dimension.

27. The air freshener of claim 26 wherein a portion of said metering sheet first face being permanently fixed to said first sheet second face.

28. The air freshener of claim 27 wherein said odor abating member is a body of baking soda.

29. The air freshener of claim 28 wherein said odor abating layer is a body of baking soda in a binder.

30. The air freshener of claim 29 wherein said metering sheet is a thin plastic sheet having an array of holes therein.
